(19) United States
(12) Patent Application Publication
(10) Pub. No.: US 2025/0155607 A1
(43) Pub. Date: May 15, 2025

(54) META OPTICAL ELEMENTS THAT INCLUDE AN OPTICAL MOTH-EYE STRUCTURE

(71) Applicant: NIL Technology ApS, Kongens Lyngby (DK)

(72) Inventors: Martin Balimann, Zurich (CH); Moritz Schmidlin, Zurich (CH)

(21) Appl. No.: 18/839,928

(22) PCT Filed: Feb. 20, 2023
(86) PCT No.: PCT/EP2023/054224

§ 371 Date: Aug. 20, 2024

Related U.S. Application Data
(60) Provisional application No. 63/313,077, filed on Feb. 23, 2022.

(51) Int. Cl. G02B 1/118; G02B 1/00; G02B 5/02

(52) U.S. Cl. CPC G02B 1/118; G02B 1/002; G02B 5/0294; G02B 2207/101

(57) ABSTRACT

The present disclosure describes meta optical elements that include an optical moth-eye structure. In some implementations, an apparatus includes a substrate, and an optical metastructure, including meta-atoms, disposed on the substrate. An encapsulant encapsulates the metastructure, and an optical moth-eye structure is provided in a surface of the encapsulant.

### FIELD OF THE DISCLOSURE

The present disclosure relates to meta optical elements that include an optical moth-eye structure.

### BACKGROUND

Advanced optical elements such as meta optical elements (MOEs) may include distributed small structures (e.g., meta-atoms) arranged to interact with light in a particular manner. For example, a metastructure can include a surface with a distributed array of nanostructures. The nanostructures may, individually or collectively, interact with light waves. For example, the nanostructures or other meta-atoms may change a local amplitude, a local phase, or both, of an incoming light wave.

In some applications, the meta-atoms are encapsulated to provide for mechanical protection. MOE performance, however, tends to be highly sensitive to variations in the encapsulant thickness. For example, variations in thickness greater than λ/4 (where λ is the intended operating wavelength of the MOE) may result in destructive and/or constructive optical interference.

### SUMMARY

The present disclosure describes methods and apparatus in which an optical moth-eye structure is provided in the surface of an encapsulant for a meta-optical element (MOE).

For example, in accordance with one aspect, the present disclosure describes an apparatus that includes a substrate, an optical metastructure, including meta-atoms, disposed on the substrate, an encapsulant encapsulating the metastructure, and an optical moth-eye structure in a surface of the encapsulant.

Some implementations include one or more of the following features. For example, in some implementations, the optical moth-eye structure is imprinted into the surface of the encapsulant. The optical moth-eye structure can include, for example, an array of antireflective structures (e.g., an array of parabolic nano-hemispheres). In some instances, the encapsulant is composed of a polymer or a spin-on-glass.

In some implementations, the encapsulant includes a boundary region laterally surrounding the metastructure, and the boundary region has a channel therein. In some cases, the apparatus includes a spacer that has a first end disposed in the channel and that has a second end for attachment to an optical component or a housing. In some cases, adhesive is disposed in the channel, and an optoelectronic component is mounted on a lead frame, wherein the lead frame is attached to the adhesive. In some implementations, the encapsulant includes a boundary region laterally surrounding the metastructure, and a spacer extends from the boundary region in a direction away from the substrate, wherein the spacer is integrated with, and composed of a same material as, the encapsulant.

In some implementations, the apparatus included a supplemental optical structure in or on the boundary region. The supplemental optical structure can be composed, for example, of a same material as the optical moth-eye structure. In some instances, the supplemental optical structure includes a diffractive optical element-type structure.

In some implementations, the apparatus includes a boundary region that laterally surrounds the metastructure, wherein at least a portion of the boundary region is composed of a same material as the meta-atoms and wherein the portion of the boundary region has a thickness greater than a height of the meta-atoms.

In some implementations, the apparatus includes a second encapsulant over the optical moth-eye structure.

The disclosure also describes a method that includes providing an optical metastructure, including meta-atoms, disposed on a substrate. The method further includes providing an encapsulant on the metastructure, and forming an optical moth-eye structure in a surface of the encapsulant.

Some implementations include one or more of the following features. For example, in some cases, the method includes imprinting the optical moth-eye structure into the surface of the encapsulant. In some cases, the method includes spin coating the encapsulant on the metastructure.

Some implementations include imprinting a channel into a boundary region of the encapsulant, wherein the boundary region laterally surrounds the metastructure. The channel can be imprinted into the boundary region, for example, at a same time as imprinting the optical moth-eye structure into the surface of the encapsulant. Some implementations include imprinting a supplemental optical structure in or on a boundary region of the encapsulant, wherein the boundary region laterally surrounds the metastructure, and wherein the supplemental optical structure is composed of a same material as the optical moth-eye structure. The supplemental optical structure can be imprinted, for example, at a same time as the optical moth-eye structure is imprinted onto a surface of the metastructure.

Some implementations provide one or more of the following advantages. For example, in some implementations, the optical moth-eye structure can desensitize the MOE to variations in the encapsulant thickness and can reduce or eliminate reflections that might otherwise occur at the air-encapsulant interface. In some cases, the moth-eye structure may be effective for a range of non-normal angles of incident light. Further, in some cases, the moth-eye structure may be effective over a relatively wide range of incident wavelengths (e.g., a broader range compared to an anti-reflective coating (ARC)).

In some instances, optical moth-eye structures may not need to be customized for different MOE designs, as the principal design criteria is operational wavelength. Consequently, different MOE designs configured for different optical applications, but the same operational wavelength, may use the same moth-eye tool during manufacturing. Further, imprinting the moth-eye structure can, in some instances, enable the integration of additional features into the MOE.

Other aspects, features and advantages will be readily apparent from the following detailed description, the accompanying drawings and the claims.

### BRIEF DESCRIPTION OF THE DRAWINGS

FIG. 1 illustrates an example of a stage in the fabrication of a meta optical element (MOE).

FIG. 2 illustrates an example of a MOE including an imprinted optical moth-eye structure.

FIG. 3 illustrates another example of a MOE including an optical moth-eye structure.

FIG. 4 illustrates another example of a MOE including an optical moth-eye structure and including a channel in a boundary region of the MOE.

FIG. 5 illustrates an example of another component attached to the MOE of FIG. 4 by a spacer.

FIG. 6 illustrates an example of an MOE including an optical moth-eye structure and an integrated spacer.

FIG. 7A illustrates the MOE of FIG. 4 including adhesive in the channel.

FIG. 7B illustrates another component attached to the MOE of FIG. 7A using the adhesive.

FIG. 8 illustrates an example of a MOE including an optical moth-eye structure and including a supplemental optical structure in a boundary region of the MOE.

FIG. 9 illustrates an example of a MOE an optical moth-eye structure and including a stray light inhibition region.

FIG. 10 illustrates an example of a MOE an optical moth-eye structure and including an encapsulant over the optical moth-eye structure.

### DETAILED DESCRIPTION

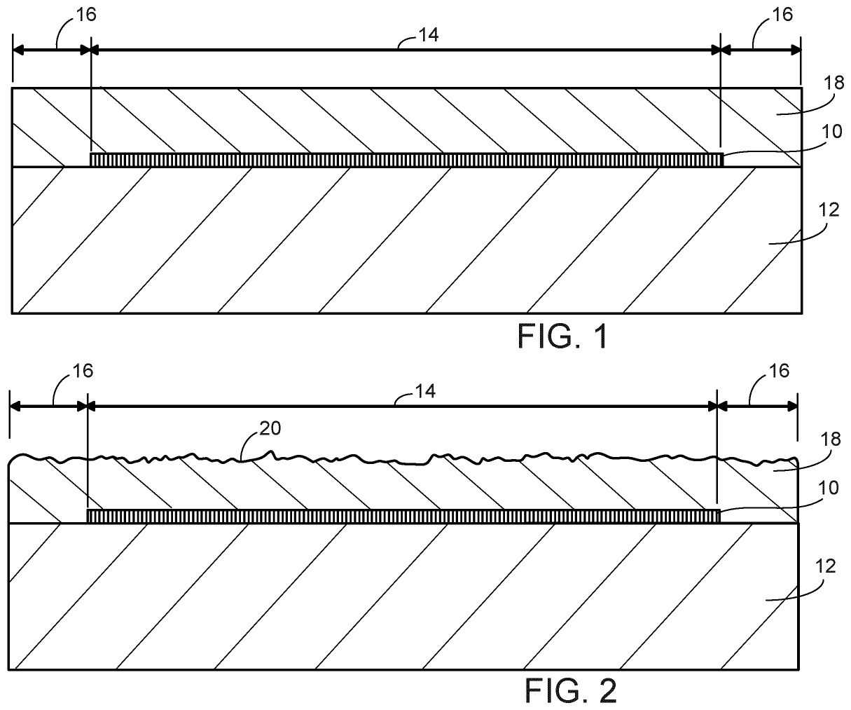

As shown in FIG. 1, a metastructure 10 includes meta-atoms (e.g., nanostructures) formed on a substrate 12. The substrate 12 may be composed, for example, of glass or silicon. In some instances, the meta-atoms are formed, for example, by etching into a wafer (e.g., an amorphous silicon wafer) disposed on the substrate 12. When the meta-atoms are in a particular arrangement, the metastructure 10 may act as an optical element such as a lens, lens array, beam splitter, diffuser, polarizer, bandpass filter, or other optical element. In some instances, the metastructure 10 may perform optical functions that are traditionally performed by refractive and/or diffractive optical elements. The meta-atoms may be arranged, in some cases, in a pattern so that the metastructure functions, for example, as a lens, grating coupler or other optical element. In other instances, the meta-atoms need not be arranged in a pattern, and the metastructure can function, for example, as a fanout grating, diffuser or other optical element. In some implementations, the metasurfaces may perform other functions, including polarization control, negative refractive index transmission, beam deflection, vortex generation, polarization conversion, optical filtering, and plasmonic optical functions.

In some instances, as shown in the example of FIG. 1, the metastructure 10 is disposed in an active region 14 that is surrounded laterally by a boundary region 16. In the example of FIG. 1, the metastructure does not extend into the boundary region 16. As further illustrated in FIG. 1, the meta-atoms of the metastructure 10 are encapsulated by an encapsulant 18, which can provide mechanical protection. The encapsulant 18 can be, for example, a polymer or a spin-on-glass applied by spin coating.

As indicated by FIG. 2, during subsequent processing, an optical moth-eye structure 20 is imprinted into the surface of the encapsulant 18. For example, an imprint tool can be pressed into the substantially planar surface of the encapsulant to form the imprinted optical moth-eye structure 20. An optical moth-eye structure refers to an array of antireflective structures such as arrays of parabolic nano-hemispheres or other protuberances having dimensions smaller than the operational wavelength of the light to be incident upon them (e.g., infra-red or visible light). The protuberances can act as a region of graded refractive index at the interface between the two media on either side of the interface. The optical moth-eye structure 20 can impart anti-reflective properties and, in some implementations, can provide good durability, can work over a relatively broad wavelength range with little or no angular dependence, and can be used in both high- and low-power applications.

Although FIG. 1 shows the metastructure 10 for a single meta optical element (MOE), the imprinting may take place with respect to a large substrate (e.g., a wafer) that is processed to form multiple MOEs. That is, in some instances, the substrate 12 is a wafer on which an array of tens, hundreds, or even thousands of MOEs are fabricated. The wafer subsequently can be diced into separate individual MOEs.

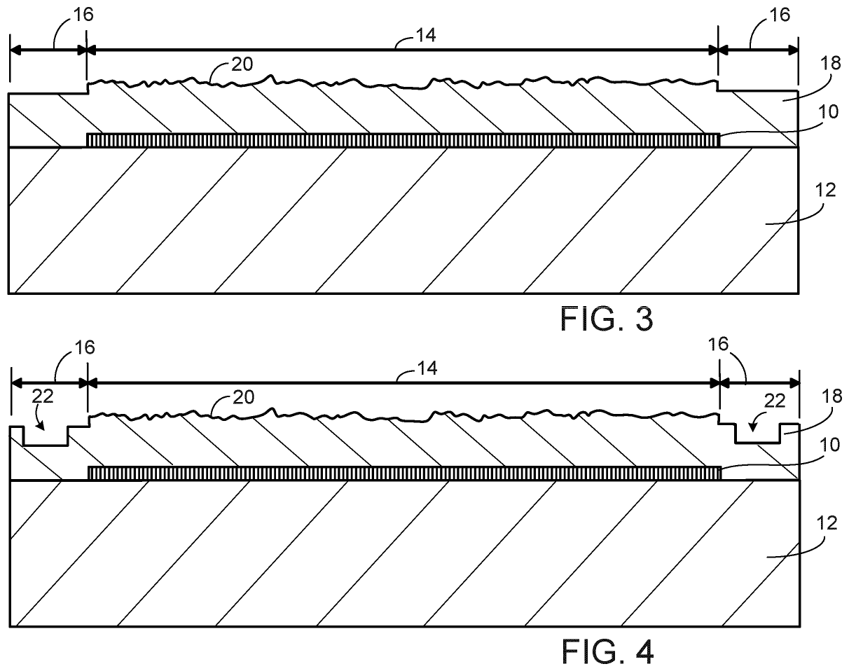

As illustrated in the example of FIG. 2, the moth-eye structure 20 extends over the entire upper surface of the substrate 12. In other implementations, however, the moth-eye structure 20 may not extend over the entire upper surface of the substrate. For example, in some cases, as illustrated in FIG. 3, the moth-eye structure 20 extends over substantially the entire active region 14, but does not extend into the boundary region 16. In some instances, the boundary region 16 can lower the amount of stray light passing though the boundary region by acting as a moth-eye aperture.

In some implementations, for example where the optical moth-eye structure 20 does not extend into the boundary region 16, a supplemental mechanical structure (e.g., a channel, a trough or a spacer) can be imprinted into the encapsulant 18 in the boundary region 16. For example, FIG. 4 illustrates an implementation that includes a channel 22 as the supplemental mechanical structure. The supplemental mechanical structure can be imprinted at the same time as imprinting the optical moth-eye structure.

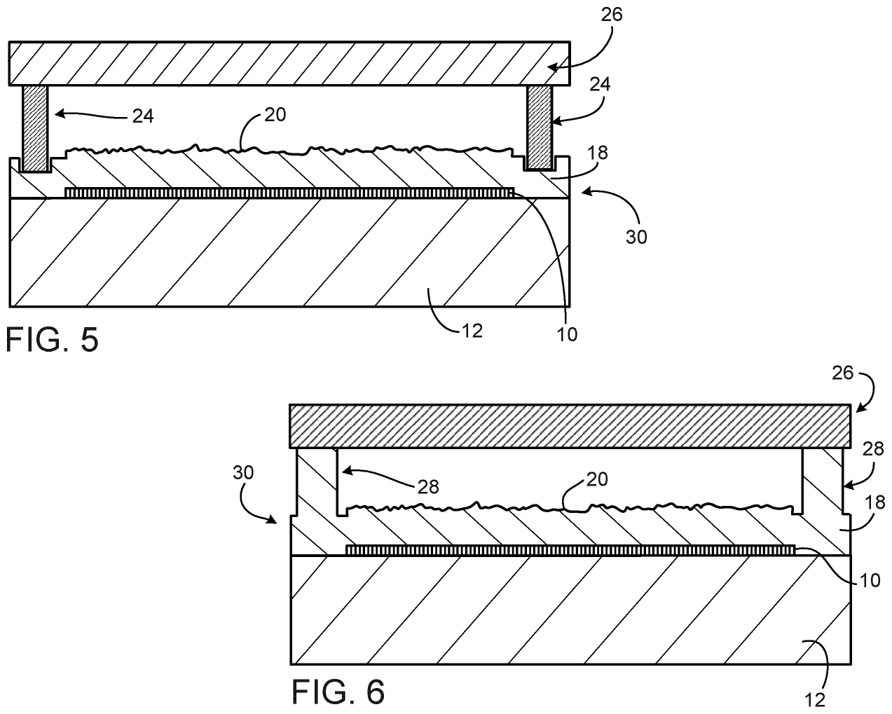

In some implementations, the supplemental mechanical structure may help prevent damage to the optical moth-eye structure 20 during dicing, and/or may help prevent adhesive from flowing onto the optical moth-eye structure 20. Further, in some cases, the supplemental mechanical structure may facilitate other assembly processes. For example, in some instances, as shown in FIG. 5, a spacer 24 can be mounted in the channel 22. Other components, such as a refractive optical element 26 (e.g., a lens) or a housing, may be assembled with the MOE 30 by attaching the other component 26 to the free end of the spacer 24 such that the spacer separates the other component 26 from the MOE 30 by a fixed distance.

In some implementations, an integrated spacer 28 composed, for example, of the same material as the encapsulant 18 can be provided as the supplemental mechanical structure, as shown in FIG. 6. Other components, such as a refractive optical element 26 (e.g., a lens) or a housing, may be assembled with the MOE 10 by attaching the other component 26 to the free end of the spacer 28 such that the spacer separates the other component 26 from the MOE 10 by a fixed distance.

In some cases, the spacers 24, 28 can be used to grip the MOE when mounting or assembling the MOE to other components.

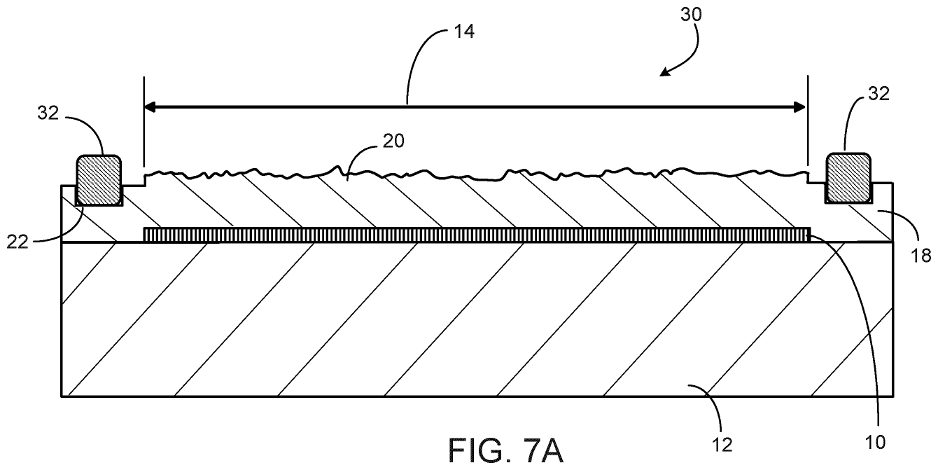

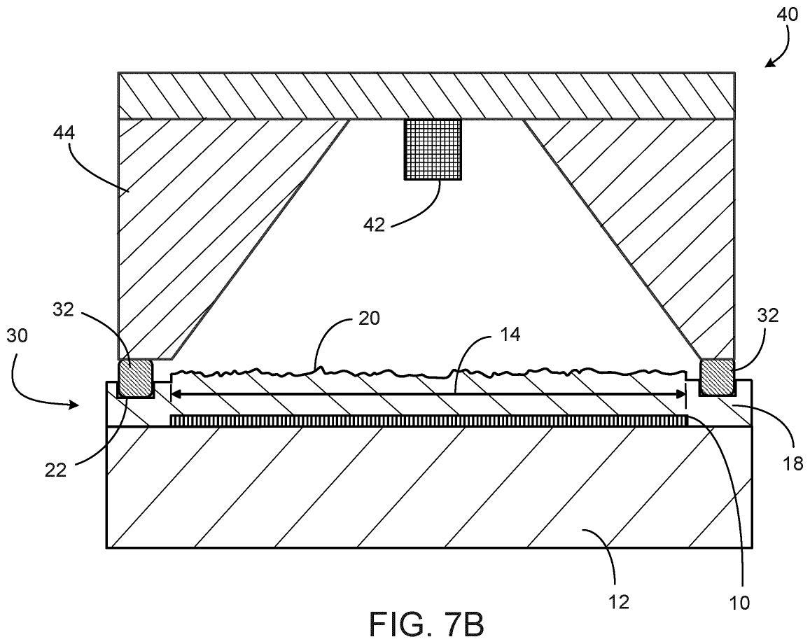

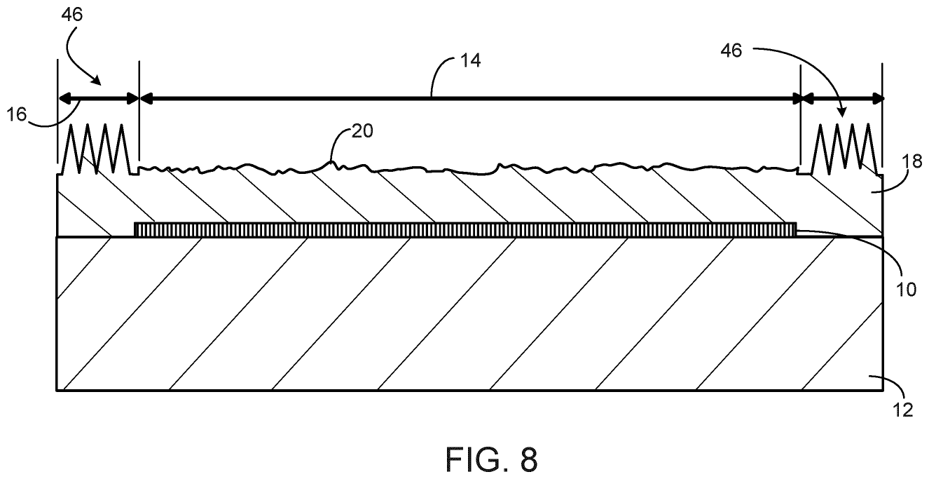

In some applications, as shown in FIG. 7A, adhesive 32 can be provided in a channel 22 located in the boundary region that laterally surrounds the active region 14 of the MOE 30. The channel 22 can help control flow of the adhesive 32. For example, in some instances, the channel 22 can help prevent the adhesive from flowing onto the optical moth-eye structure 20. As shown in FIG. 7B, another component 40 subsequently can be assembled with the MOE 30 by using the adhesive 32 to attach the MOE to the other component. In the example of FIG. 7B, the other component 40 to which the MOE 30 is attached includes an active optoelectronic component (e.g., a light emitter or light sensor) 42 mounted on a lead frame 44.

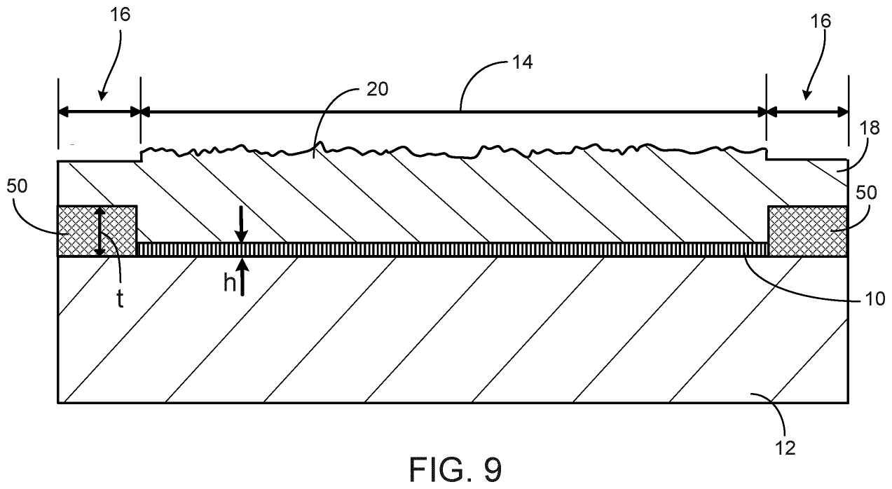

In some implementations, as shown in FIG. 8, a supplemental optical structure 46 can be provided in or on the boundary region that laterally surrounds the active region 14. In some cases, the supplemental optical structure 46 can be imprinted at the same time as, and be composed of the same material as, the optical moth-eye structure 20. The supplemental optical structure 46 can be configured to perform various optical functions such as, coupling out light that propagates in material with total internal reflection in a controlled manner, directing stray light in specific directions (for example towards absorbing side walls) to avoid impinging on a sensor, or diffusing stray light. In the example of FIG. 8, the supplemental optical structure 46 is illustrated as a diffractive optical element (DOE)-type structure. However, in some implementations, other types of supplemental optical structures (e.g., diffusers, gratings, light guides, refractive elements) can be imprinted onto the boundary region.

In some implementations, as shown in FIG. 9, a portion 50 of the boundary region 16 that laterally surrounds the metastructure 10 can be a relatively thick layer of the same material as the meta-atoms in the metastructure. For example, the portion 50 of the boundary region can have a thickness (t) greater than a height (h) of the meta-atoms. The relatively thick layer 50 can, in some instances, help inhibit transmission of stray light or re-direct stray light. In some implementations, the layer 50 is provided as follows. When the meta-atoms are etched, for example, from an amorphous silicon or other wafer, the area surrounding the etched meta-atoms can be etched to a lesser degree, or can remain un-etched, so that a relatively thick layer of the meta-atom material remains in the boundary region 16 laterally surrounding the metastructure 10. If, for example, the material from which the meta-atoms are etched is effective at absorbing the operational wavelength (e.g., a wavelength in the infra-red part of the spectrum), then the portion 50 of the boundary region may be useful in blocking stray infra-red light.

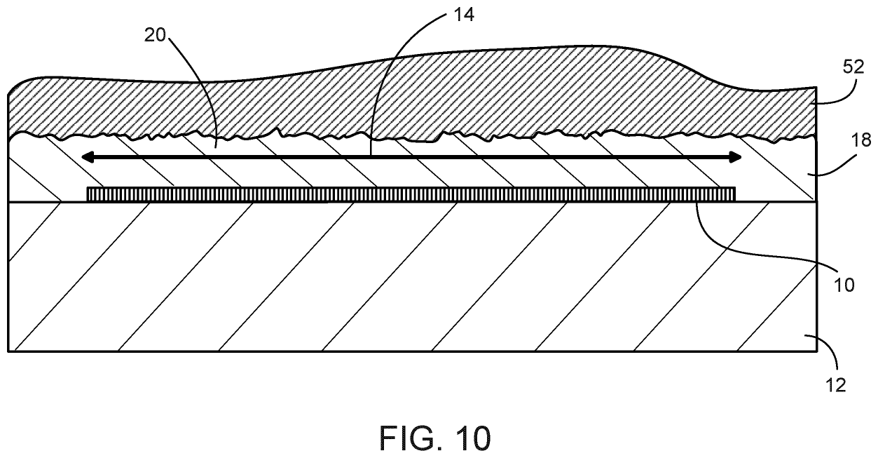

In some instances, as shown in FIG. 10, an encapsulant 52 is provided over the optical moth-eye structure 20. In some implementations, this second encapsulant 52 helps provide protection from mechanical damage to the optical moth-eye structure 20. The second encapsulant 52 can have an index of refraction (n_{E2}) different from an index of refraction (n_{E1}) of the first encapsulant 18. Thickness variations in the encapsulant 52 greater than λ/4 appear to impact the optical moth-eye structure 20 less than similar thickness variations in the encapsulant 18 would impact the metastructure 10. Nevertheless, in some cases, an ARC may be provided over the encapsulant 52 for the optical moth-eye structure 20.

While this document contains many specific implementation details, these should not be construed as limitations on the scope of any inventions or of what may be claimed, but rather as descriptions of features specific to particular embodiments. Certain features that are described in this document in the context of separate embodiments can also can be implemented in combination in a single embodiment. Conversely, various features that are described in the context of a single embodiment can also can be implemented in multiple embodiments separately or in any suitable sub-combination. Various modifications can be made to the foregoing examples. Accordingly, other implementations also are within the scope of the claims.

1. An apparatus comprising:
a substrate;
an optical metastructure, including meta-atoms, disposed on the substrate;
an encapsulant encapsulating the metastructure; and
an optical moth-eye structure in a surface of the encapsulant.

2. The apparatus of claim 1 wherein the optical moth-eye structure is imprinted into the surface of the encapsulant.

3. The apparatus of claim 1, wherein the optical moth-eye structure includes an array of antireflective structures.

4. The apparatus of claim 3 wherein the array of antireflective structures includes an array of parabolic nano-hemispheres.

5. The apparatus of claim 1, wherein the encapsulant is composed of a polymer or a spin-on-glass.

6. The apparatus of claim 1, wherein the encapsulant includes a boundary region laterally surrounding the metastructure, the boundary region having a channel therein.

7. The apparatus of claim 6 further including a spacer that has a first end disposed in the channel and that has a second end for attachment to an optical component or a housing.

8. The apparatus of claim 6 further including:
adhesive disposed in the channel; and
an optoelectronic component mounted on a lead frame, wherein the lead frame is attached to the adhesive.

9. The apparatus of claim 1, wherein the encapsulant includes a boundary region laterally surrounding the metastructure, and wherein a spacer extends from the boundary region in a direction away from the substrate, wherein the spacer is integrated with, and composed of a same material as, the encapsulant.

10. The apparatus of claim 9 further including a supplemental optical structure in or on the boundary region.

11. The apparatus of claim 10 wherein the supplemental optical structure is composed of a same material as the optical moth-eye structure.

12. The apparatus of claim 1, wherein the supplemental optical structure includes a diffractive optical element-type structure.

13. The apparatus of claim 1, including a boundary region that laterally surrounds the metastructure, wherein at least a portion of the boundary region is composed of a same material as the meta-atoms and wherein the portion of the boundary region has a thickness greater than a height of the meta-atoms.

14. The apparatus of claim 1, further including a second encapsulant over the optical moth-eye structure.

15. A method comprising:
providing an optical metastructure, including meta-atoms, disposed on a substrate;
providing an encapsulant on the metastructure; and
forming an optical moth-eye structure in a surface of the encapsulant.

16. The method of claim 15 including imprinting the optical moth-eye structure into the surface of the encapsulant.

17. The method of claim 15, including spin coating the encapsulant on the metastructure.

18. The method of claim 15, including imprinting a channel into a boundary region of the encapsulant, wherein the boundary region laterally surrounds the metastructure.

19. The method of claim 18 including imprinting the channel into the boundary region at a same time as imprinting the optical moth-eye structure into the surface of the encapsulant.

20. The method of claim 15, including imprinting a supplemental optical structure in or on a boundary region of the encapsulant, wherein the boundary region laterally surrounds the metastructure, and wherein the supplemental optical structure is composed of a same material as the optical moth-eye structure.

21. The method of claim 20 wherein the supplemental optical structure is imprinted at a same time as the optical moth-eye structure is imprinted onto a surface of the metastructure.
